(19) United States
(12) Patent Application Publication
(10) Pub. No.: US 2016/0000530 A1
(43) Pub. Date: Jan. 7, 2016

(54) Base Configuration for Orthodontic Bracket

(71) Applicant: WORLD CLASS TECHNOLOGY CORPORATION, AN OREGON CORPORATION, McMinnville, OR (US)

(72) Inventors: Rolf Hagelganz, Dundee, OR (US); Juergen Bathen, McMinnville, OR (US)

(73) Assignee: WORLD CLASS TECHNOLOGY CORPORATION, McMinnville, OR (US)

(21) Appl. No.: 14/769,081

(22) PCT Filed: Nov. 21, 2013
(86) PCT No.: PCT/US13/71145

§ 371 Date: Aug. 19, 2015

Related U.S. Application Data
(60) Provisional application No. 61/768,327, filed on Feb. 22, 2013.

(51) Int. Cl. A61C 7/16

(52) U.S. Cl. CPC A61C 7/16

(57) ABSTRACT

A base of an orthodontic bracket includes a matrix of bond pads that form channels to hold adhesive. These channels are oriented at acute angles to a long tooth axis to better resist shear forces impinging from random directions.

### CROSS-REFERENCE TO RELATED APPLICATIONS

This application is related to and claims priority from U.S. Provisional Application Ser. No. 61/768,327 filed Feb. 22, 2013.

### BACKGROUND OF THE INVENTION

Orthodontic brackets consist generally of a base portion and a bracket body. The base portion is bonded to a patient's tooth while the bracket body supports an archwire. During treatment, the archwire transmits forces to the tooth causing it to realign, thus correcting various conditions of malocclusion. In order for forces to be coupled effectively to the tooth, the base portion of the bracket must adhere to the tooth and resist slippage and twisting on the tooth surface itself.

The base portions of brackets are secured to the teeth with an adhesive. In conventional brackets the base, which is the underside of the bracket, has a matrix of bond pads that form an attaching surface. These are small rectangular pads as shown in the prior art drawing of FIG. 1. Typically, the bond pads are square and are arrayed in rows and columns to form a rectangular or square matrix with even spacing between adjacent bond pads. The bond pads depend from the lingual surface of a bracket, i.e., its underside and therefore have side walls that are perpendicular to the surface of the tooth. The walls of these bond pads form channels that hold adhesive. The problem with such an arrangement is that the conventional ordered rectangular matrix does not effectively resist shear forces.

A pad is most resistant to forces applied nearly parallel to the contact area between adjacent side walls and, hence, the channels holding the bonding adhesive. In conventional brackets, this is in the mesial-distal and gingival-occlusal directions. The channels formed by a regular array of bond pads are most resistant to forces directed at the channels, along their longest axes, because that is where most of the adhesive is concentrated. Twisting and shear forces, however, do not come from these directions all the time. They may impinge at acute or obtuse angles to the mesial-distal or occlusal-gingival axes. Some forces acting on the bracket may be directed at right angles to the rectangular sides of the bracket, but in addition, forces from random directions may be applied to the bracket by the simple acts of eating and chewing. In addition, food that bears against archwires in the act of eating may have a tendency to cause the bracket to twist about a lingual-labial axis due to the rotational lever action of a wire between brackets.

### SUMMARY OF THE INVENTION

A base of an orthodontic bracket includes a matrix of bond pads that form channels to hold adhesive. The adhesive sets in the channels and forms a bond with the tooth. These channels are oriented at different angles to a long tooth axis to better resist shear or twisting forces impinging from random directions. The channels may be oriented at a mix of acute and obtuse angles to the long tooth axis and may form symmetrical patterns on both sides of the axis.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a bottom view of a prior art orthodontic appliance or bracket.

FIG. 2 is a perspective view of an orthodontic bracket.

FIG. 3 is a top view of a typical orthodontic bracket.

FIG. 4 is a bottom view of the orthodontic bracket of FIG. 3 having a bond pad configuration of a first type.

FIG. 5 is a side cutaway view taken along line 5-5 of FIG. 3.

FIG. 6 is a side cutaway view taken along line 6-6 of FIG. 3.

FIG. 7 is a bottom view of an alternate embodiment of a bond pad pattern on the underside of an orthodontic bracket.

FIG. 8 is a bottom view of another alternative embodiment of a bracket having a bond pad pattern on the underside of its base.

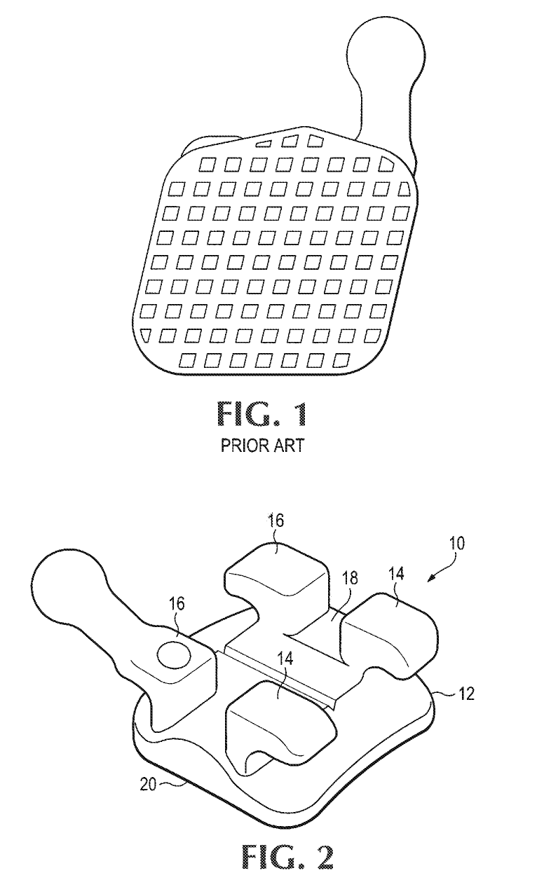

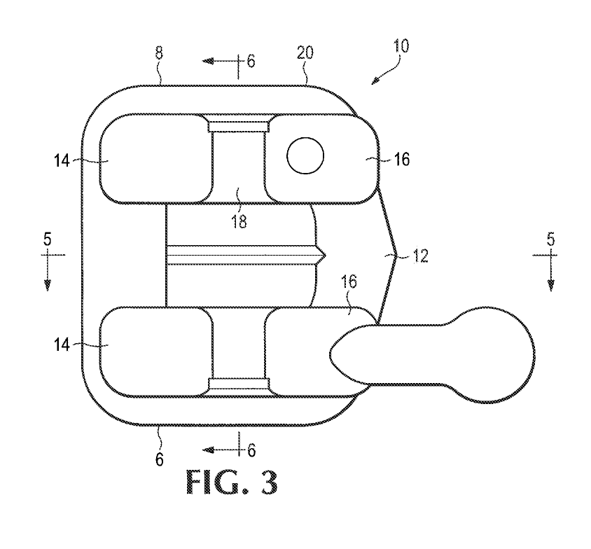

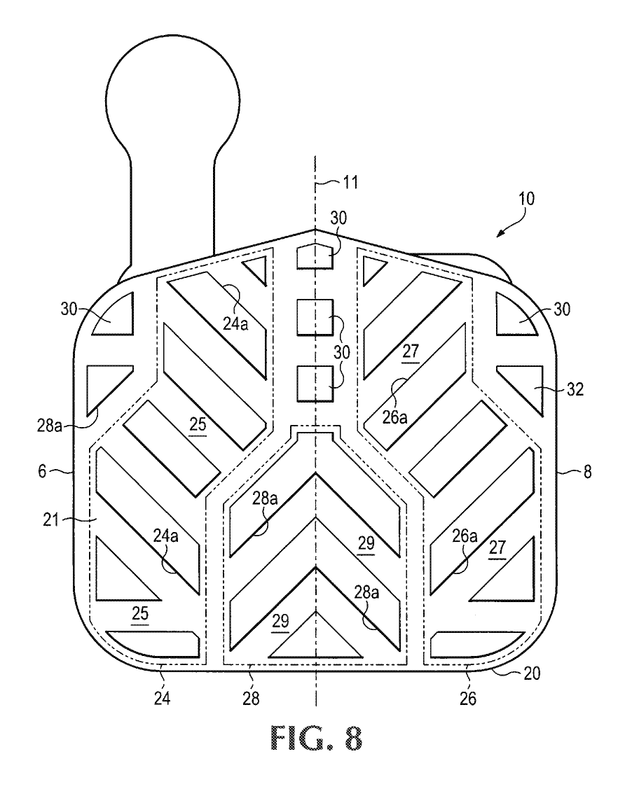

### DETAILED DESCRIPTION OF THE VARIOUS EMBODIMENTS

The bond pads on the underside of an orthodontic bracket base create channels that may be filled with the adhesive, which secures the base to the tooth. The bond pad configuration therefore determines the contact area of the adhesive with the tooth and this in turn defines the pattern of resistance to force vectors at the tooth/bracket interface.

In one aspect of the invention, an orthodontic appliance has a base adapted to be applied to the surface of a human tooth, the base having a contact surface that comprises a plurality of spaced apart bond pads. The bond pads have side walls oriented at acute angles with respect to an imaginary line called a center long tooth axis, which bisects the base and extends in a gingival-occlusal direction. A first plurality of bond pads have side walls oriented at a first acute angle with respect to the long tooth axis and a second plurality of bond pads are on the other side of the axis and are oriented at a second acute angle. Preferably, the second acute angle is substantially orthogonal with respect to said first acute angle and are thus at the same angle to the long tooth axis on either side.

In a broader sense the base has a bond pad surface comprising a plurality of bond pads having lingual end surfaces, the bond pads having side walls so as to form channels in the base to be filled with adhesive where at least some channels extend at angles to the long tooth axis that are neither parallel nor perpendicular thereto. The channels may be grouped so that all of them on one side of the long tooth axis form the same angle with the axis and a mirror image group of channels may exist on the other side of the axis. In addition a third group of channels may be formed from bond pad side walls extending at an obtuse angle, that is, one shifted 90 degrees with respect to the first two groups.

A bracket 10 includes a body portion 12, which has pairs of tie wings 14, 16 that extend in occlusal and gingival directions, respectively. An archwire slot 18 is located between the pairs of tie wings 14 and 16 and receives an archwire (not shown) for generating restorative forces that correct conditions of malocclusion.

The bracket body 12 has a base portion 20. Formed in the base portion 20 is a bonding surface 21, which comprises a plurality of bond pads. The bond pads have differing shapes and orientations as shown best in FIGS. 4, 7 and 8. The bond pads have varying shapes that create channels for the adhesive, which in turn help the bracket to remain secured to the surface of a tooth when the bracket is subjected to shear forces coming from random angular directions or twisting forces occasioned by food or the like bearing on the archwires between teeth.

The different shapes of the bond pads and their placement provides for a pattern of channels on the underside of the bracket which, when filled with adhesive material resist forces that could potentially dislodge the bracket 10 from the tooth. The bond pads are preferably placed in a pattern that is symmetrical with a central axis line, identified as long tooth axis 11 on the drawing of FIGS. 4 and 7, and extending generally in an occlusal-gingival direction. The bond pads are three dimensional projections or stubs extending from the underside of the base 20. In the plane of the bottom surface 21, the feet of these pads may take the form of different shapes and sizes such as square, trapezoid, parallelogram, or triangle. This list is not exhaustive and other shapes may be used as desired.

In preferred embodiments (see FIGS. 4, 7 and 8) at least some of the bond pads have side walls that are oriented at acute and obtuse angles with respect to the long tooth axis 11 and thus create channels of the same orientation. Preferably at least a plurality of such bond pads are oriented at a plus or minus 45 degree angle to this axis and another plurality is oriented at complementary plus and minus 135 degree obtuse angles. The terms “plus” and “minus” are arbitrary and refer merely to whether the angle is to one side of the long tooth axis or the other. Both are 45 degrees using the long tooth axis as a reference line. An obtuse angle is merely one that is shifted 90 degrees to either of the 45-degree angles. Side walls oriented at 45 degrees on opposite sides of the long tooth axis will be orthogonal to each other and are orthogonal to side walls oriented at 135 degrees to the long tooth axis.

FIG. 4 shows the bottom surface 21 of the bracket 10. The bracket 10 is generally oriented in an occlusal-gingival direction. An imaginary line indicated by dot-dashed line 11 is designated the long tooth axis. The long tooth axis 11 of the bracket (refer also to FIG. 7) is a bracket center line that bisects the bracket and which is generally parallel to the mesial-distal side edges 6, 8 of the bracket 10.

Referring to FIG. 4, there are several different pluralities of bond pads, each having distinct shapes and orientations. A first plurality of bond pads 24 have side walls such as walls 24a that form channels 25 that are oriented at an acute angle with respect to the long tooth axis 11. This angle is preferably designed to be substantially a 45-degree angle. A second group of bond pads 26 also has side walls 26a forming channels 27 that are oriented at a 45-degree angle with respect to the long tooth axis but are a mirror image of the channels 25 on the other side of the axis 11.

A third grouping of bond pads 28 may have side walls 28a that are oriented at obtuse angles with respect to the long tooth axis 11. The obtuse angle is approximately 135 degrees, in actuality a 45-degree angle shifted counterclockwise by 90 degrees. The bond pads in the third group are shaped like chevrons and triangles bisected by and substantially symmetrical with the long tooth axis 11 having side walls 28a that form channels 29 on both sides of the axis. These channels will be at 90-degree angles to the channels 25, 27 formed by the side walls of the bond pads in groups 24 and 26. It will be appreciated that there are equal numbers bond pad side walls forming both obtuse angles to the long tooth axis and acute angles to the long tooth axis 11 on either side of the axis. Preferably, the patterns of bond pads on either side of the long tooth axis 11 are mirror images of each other in order to achieve symmetry and thus a balance of resistive force with respect to the axis 11.

There is a fourth group of bond pads 30, which have side walls 30a that are parallel to the long tooth axis 11. Some of these bond pads have side walls oriented at acute or obtuse angles and are thus generally triangular in shape. Bond pad 32 is exemplary.

The bond pads may have varied shapes including rectangle, parallelogram, triangle, trapezoid, rhombus, or variations of these shapes. The exact shape of each bond pad is dictated by space considerations and the need for certain types of side wall angles to maintain balance and symmetry on either side of the long tooth axis. Some bond pads have curved side walls such as the bond pads at the corners of base 12. However, the number and type of shapes employed, the pattern of bond pads provides a plurality of side walls oriented at differing angles so as to provide channels to be filled with adhesive that will be normal to force vectors impinging on the brackets from different directions. Thus, some degree of strength is provided to resist shear forces or twisting forces that may come from any direction.

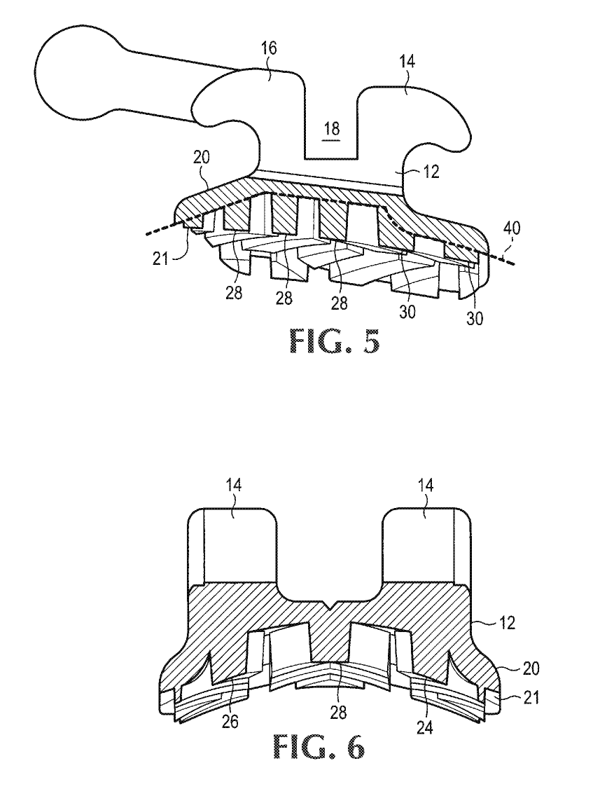

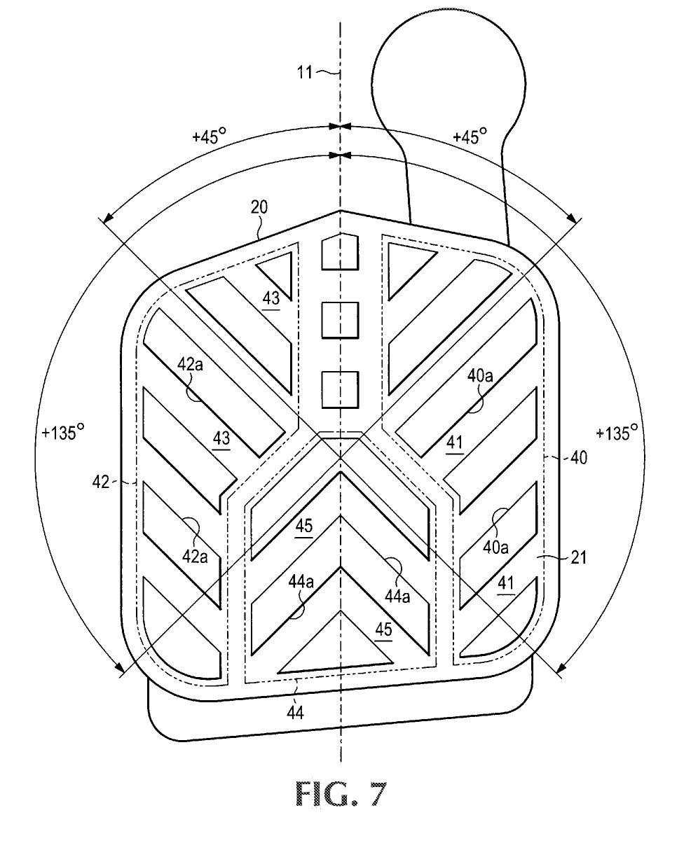

The bond pad surface 21 that is formed of the ends of the individual bond pads is curved in two dimensions as shown best in FIGS. 5 and 6. The reason for this is that human teeth are not planar, but have curved surfaces. The radii of curvature differs for each tooth, but an exemplary set of radii for the upper right 4 and 5 bicuspids are 0.130 inches in the mesial-distal plane and 0.750 inches in the occlusal-gingival plane.

The bond pads have various lengths depending upon where on the underside of the base they are located. In general, bond pads located near the center of the base are longer in the labial-lingual direction than those located near the edges, which are shorter. The bond pads are separated by spaces, which form a maze of channels. Adhesive is typically applied to the bottom of the base 12 and it flows into these spaces, filling them. The longer bond pads thus provide deeper spaces between pads that may be filled with more adhesive, which in turn makes for a stronger bond at or near the center of the bracket's bond surface 21.

A profile of the underside of the bracket is shown in FIG. 5. A base plane 40, shown in dashed outline, illustrates the depth at which the bond pads terminate at the underside of the base 12. Thus, bond pads, such as bond pads 28 near the center of the base surface 21, provide the deepest spaces between pads but are shallow toward the edges of the base 20. The shortest bond pads are those on the edge like bond pads 32 and 30. In FIG. 6, the bond pads 26 are preferably substantially the same length as their mirror image bond pads 24.

FIG. 7 illustrates another embodiment of a bracket base having a pattern of bond pads with side walls that are oriented at acute and obtuse angles with respect to the long tooth axis 11. A first group of bond pads 40 all has side walls 40a oriented at an acute angle to the long tooth axis 11. Preferably, the angle is 45 degrees but other angles could be employed. In addition, the angles need not be uniform. This first group of bond pads 40 forms a row of channels 41 extending generally in the gingival-occlusal direction on a first side of the long tooth axis 11. A second group of bond pads 42 is a mirror image of bond pads 40 on the opposite side of the long tooth axis 11 and forms channels 43. This group has side walls 42a which each form a 45-degree angle with respect to the long tooth axis 11 to create the channels 43. A third group of bond pads 44 is bisected by the long tooth axis 11 and has obtusely angled side walls 44a oriented substantially at a 135-degree angle to the long tooth axis 11 thus forming channels 45.

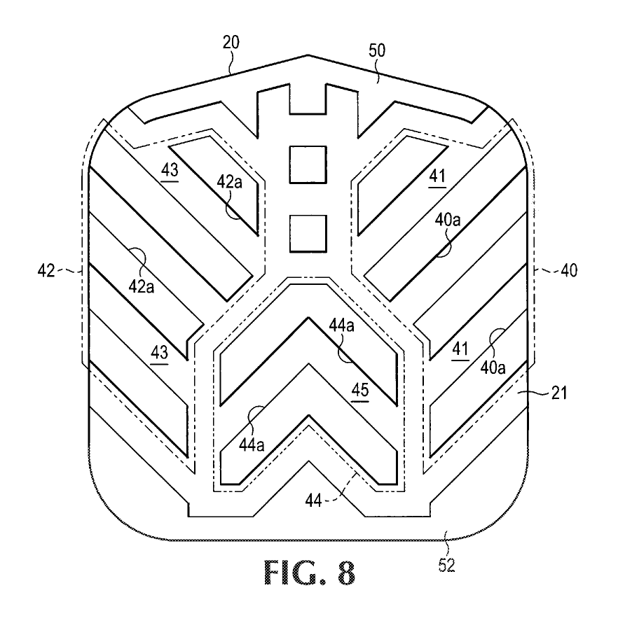

FIG. 8 is similar to the embodiment of FIG. 7 in many respects but also contains an additional component in the base surface 21. In FIG. 8, a bond pad wall or end component provides a barrier at each end of the base of the bracket so that adhesive does not flow out of channels at the edges of the base in either the occlusal or gingival directions. A gingival bond pad wall 50 extends across the gingival end of the base 20 in a mesial-distal direction and seals off the bond pad surface, blocking adhesive from seeping out. Similarly, a bond pad wall 52 extends across the occlusal end and seals off that end of the base 20. It is to be understood that bond pad walls such as walls 50 and 52 could be used with any of the embodiments of FIG. 4, 7, or 9 and are not limited to use with the embodiment of FIG. 8.

The embodiments of FIGS. 4, 7 and 8 provide pluralities of bond pads with side walls having both acute and obtuse angles relative to a central axis extending in the gingival-occlusal direction. While it has been shown that pads having side walls with 45-degree orientations are preferred, other angles may be used. For example, bond pad side walls having different orientations within the same groupings may be used. A mixture of 45 degree, 60 degree, and 30 degree side walls is possible with pads of similar angular orientations arranged in rows or columns, or they may be random. In one variation, at least a plurality of bond pads may be provided that have side walls that are neither parallel to nor perpendicular to the long tooth axis and these bond pads may be distributed randomly about the base. Preferably, however, the 45/135 degree orientations provide sufficient strength against forces impinging from directions other than mesial-distal or gingival-occlusal so that the bracket remains affixed to the tooth surface.

The terms and expressions that have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

1. An orthodontic appliance, said appliance having a center long tooth axis extending generally in a gingival-occlusal direction and having a base adapted to be applied to the surface of a human tooth, the base having a contact surface comprising a plurality of spaced apart bond pads, the bond pads having side walls forming channels in said contact surface, said channels being oriented at acute angles with respect to said center long tooth axis.

2. The orthodontic appliance of claim 1 wherein a first plurality of said bond pads have side walls oriented at a first acute angle with respect to said long tooth axis and a second plurality of said bond pads oriented at a second acute angle with respect to said long tooth axis wherein said second acute angle is substantially orthogonal with respect to said first acute angle.

3. The orthodontic appliance of claim 2 wherein said first acute angle is substantially 45 degrees.

4. The orthodontic appliance of claim 2 wherein said first and second pluralities of bond pads are equal.

5. The orthodontic appliance of claim 2 wherein said first and second pluralities of said bond pads are on opposite sides of said long tooth axis.

6. The orthodontic appliance of claim 2 further including a third plurality of bond pads bisected by said long tooth axis and having side walls forming channels oriented at right angles with respect to said first and second acute angles.

7. The orthodontic appliance of claim 6 wherein each bond pad in said third plurality includes side walls on either side of said long tooth axis extending at right angles to each other.

8. An orthodontic appliance having a base adapted to be applied to the surface of a human tooth, the base having a bond pad surface comprising a plurality of bond pads having lingual end surfaces, said bond pads having side walls, the base having a long tooth axis extending in a gingival-occlusal direction, and at least a plurality of said bond pads having parallel side walls forming a plurality of channels, said channels extending at angles to said long tooth axis wherein said angles are neither parallel nor perpendicular to said long tooth axis.

9. The orthodontic appliance of claim 8 wherein at least a first plurality of said bond pads on a first side of said long tooth axis have side walls oriented at a predetermined acute angle with respect to said axis.

10. The orthodontic appliance of claim 9 wherein at least a second plurality of said bond pads on a second side of said long tooth axis have side walls oriented at said acute angle with respect to said axis.

11. The orthodontic appliance of claim 10 further including a third plurality of bond pads having side walls on either side of said axis oriented substantially perpendicular to said acute angle.

12. The orthodontic appliance of claim 8 wherein said bond pads each have a depth relative to an underside surface of said appliance, said depth being greater in a central portion of said underside surface and diminishing toward side edges of said underside surface.

3. The orthodontic appliance of claim 8 wherein said lingual end surfaces forming said bond pad surface is contoured in shape to conform to the surface contour of a human tooth.

14. The orthodontic appliance of claim 1 further comprising an occlusal end bond pad forming a first adhesive barrier and extending across said base in a mesial-distal direction and a gingival end bond pad forming a second adhesive barrier and extending across said base in a mesial distal direction.

15. The orthodontic appliance of claim 11 further comprising an occlusal end bond pad forming a first adhesive barrier and extending across said base in a mesial-distal direction and a gingival end bond pad forming a second adhesive barrier and extending across said base in a mesial distal direction.

16. The orthodontic appliance of claim 1 wherein said contact surface is contoured in shape to conform to the surface contour of a human tooth.
